(19) United States
(12) Patent Application Publication
(10) Pub. No.: US 2009/0070254 A1
(43) Pub. Date: Mar. 12, 2009

(54) Consumer fuel quantity purchasing system

(76) Inventor: Alan John Thrush, Okemos, MI (US)

Correspondence Address: DICKINSON WRIGHT PLLC, 1875 Eye Street, NW, Suite 1200, WASHINGTON, DC, 20006, US

(21) Appl. No.: 11/898,270

(22) Filed: Sep. 11, 2007

(51) Int. Cl. G06Q 30/00

(52) U.S. Cl. 705/39

(57) ABSTRACT

A system and method for the pre-purchase of a quantity of a commodity traded in a futures market or could otherwise be hedged of any volume, at any time, using the internet. The method and system establishes a commodity purchase account for a provider to allow a user purchase of the commodity at a predetermined volume quantity, at a set price; delivering to user a means to effect the purchase of a commodity; transferring funds representing the purchase of a predetermined quantity of a predetermined commodity from a purchaser to a user; crediting the purchaser's commodity purchase account with the funds, utilizing the transferred funds to effect the purchase of the predetermined quantity of the predetermined commodity, subsequently delivering at least a part of the commodity purchase in kind from a commodity vendor to the user, and debiting the user's commodity purchase account in accordance with the quantity of the commodity delivered to the user.

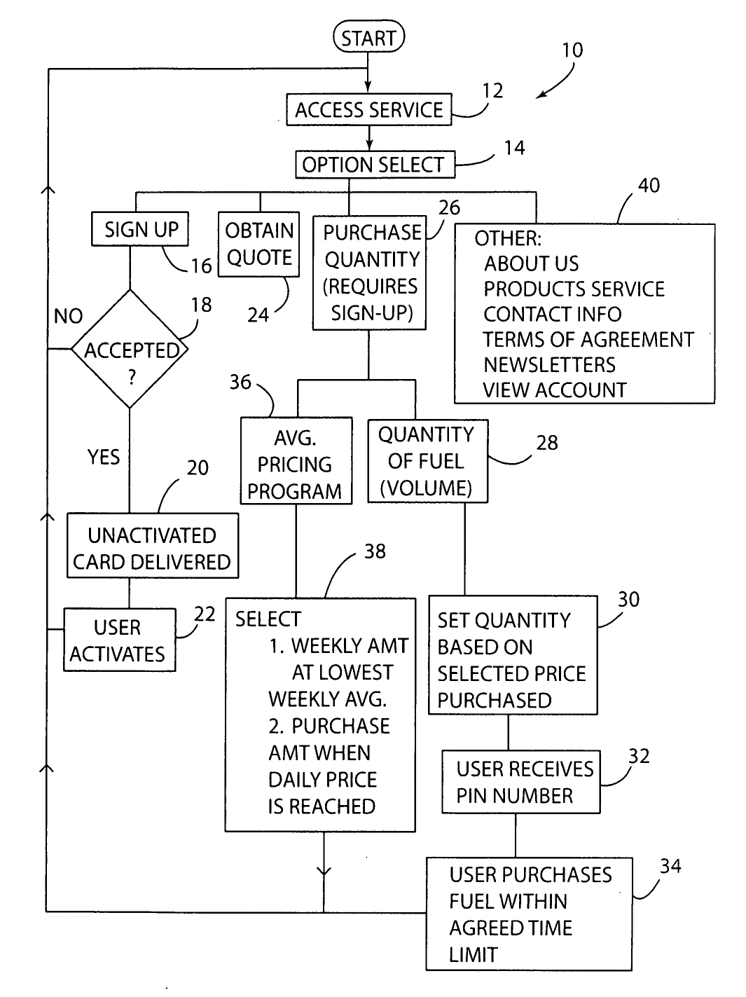

### CLAIM OF PRIORITY

None

### FIELD OF THE INVENTION

The present invention generally relates to a system and method for the pre-purchase of a quantity of a commodity and, more specifically, to a system and method to pre-purchase a quantity of fuel of any volume, at a set price, at any time, using the internet.

### BACKGROUND OF INVENTION

Volatile fuel prices are a growing problem for consumers. Often, consumers are forced to purchase fuel at prices that are sometimes much higher per gallon than they were the previous day. The average consumer is unaware of the forces that may cause such a rapid escalation in price. If all stations in a geographic area increase their price equally, the consumer has no choice but to pay the higher market price.

There are known methods in the art to pre-purchase fuel. See generally U.S. Pat. No. 6,145,741 to Wisdom et al. Unfortunately, the Wisdom system does not allow a fixing of the price of fuel; thus, the consumer is still exposed to the volatility of the market. Other systems allow for the purchase of quantities of fuels rather than price, but these systems do not reference a system to allow third parties to interact with the wholesalers and retailers of the fuel. See generally, U.S. 2003/0197060 to Coyner. The concept of prepaid large volume fuel purchase by a potential third party has been raised in the art, but there remains no detail as to how that concept could be reduced to practice without a storage facility with any specificity. See generally, U.S. 2004/0260632 to Wanasek.

Thus, there is a desire and a need in the art to provide a method and system for the average consumer to avoid the volatile nature of fuel pricing without the need to purchase large quantities of fuel in the futures market or to store in a structure. A functional system for this type of commodity purchasing is unknown in the art.

### SUMMARY OF INVENTION

Accordingly, the present invention provides a system and method for the pre-purchase of a quantity of a commodity and, more specifically, to a system and method to pre-purchase a quantity of fuel of any volume, at any time, using the internet.

Specifically, the invention provides a method and system to pre-purchase a quantity of a commodity that is traded in a futures market or could otherwise be hedged by establishing a commodity purchase account for a provider to allow a user purchase of the commodity at a predetermined volume quantity at a set price; delivering to user a means to effect the purchase of a commodity, transferring funds representing the purchase of a predetermined quantity of a predetermined commodity from a purchaser to a user, crediting the purchaser's commodity purchase account with the funds, utilizing the transferred funds to effect the purchase of the predetermined quantity of the predetermined commodity, subsequently delivering at least a part of the commodity purchase in kind from a commodity vendor to the user, and debiting the user's commodity purchase account in accordance with the quantity of the commodity delivered to the user.

Additional features of the present invention further add a method and system of establishing an account by printing a user form, signing the form, and delivering the signed form to the provider. Means to effect the purchase can be a device having readable data (i.e., credit card type) or radio-wave readable medium. Delivering a price quote to a user on request can be an optional feature of the system.

The purchase of a predetermined quantity of a predetermined commodity can use forward pricing (wherein a user may purchase a specific volume of the commodity at a predetermined price), average pricing (wherein the user can lock in the price of the commodity on a certain day of the week, month or year in certain predetermined times and dollar amounts), locking in the futures price of the commodity, but not the difference between the futures and the geographic distribution of the commodity price (hedged to purchase), locking in the difference between the futures price and geographically distributed price but not the futures price (basis contract), or to pay for the provider to lock in their prices for the user by a pricing agreement.

Other features of the present invention will become more apparent to persons having ordinary skill in the art to which the present invention pertains from the following description and claims.

### BRIEF DESCRIPTION OF THE FIGURES

The foregoing features; as well as other features, will become apparent with reference to the description and figure below, in which like numerals represent elements, and in which the Figure illustrates a flow diagram in accordance with an embodiment of the present invention.

### DETAILED DESCRIPTION OF THE INVENTION

Volatile fuel prices at the pump have prompted the need to develop a method and system for consumers to protect themselves from such movements. The present invention allows pre-purchase of fuel that is independent of the fuel suppliers, using a system and method that facilitates “hedging” in the future's market. The development of futures markets for many commodities makes it possible for consumers to take positions to offset price risk.

Unfortunately, futures contracts are seldom practical for an individual consumer, since a hedgeable quantity is frequently much larger than the needs of an individual consumer. For example, a New York Mercantile Exchange for an unleaded gasoline futures contract is 42,000 gallons. Even a mini contract at 21,000 gallons is too large for a single consumer to effectively hedge his gas consumption on a pre-paid basis. If a consumer drives 30,000 miles a year and gets 30 miles per gallon, their annual consumption is only 1,000 gallons. Using a mini-contract to lock in 20 years of consumption is not a hedge, but a speculative position. Far better and more practical would be, for example, to have a system that combined the fuel needs of 20 consumers who each use 1,000 gallons a year, so that they are purchasing one year's worth of gasoline each. An objective of the present invention is to develop a system that would make it easy, simple, and practical for the average consumer to use and for the host service provider to administer, while also being profitable.

The present invention allows a host service provider to contract the fuel price with the consumer, thus transferring the price risk and hedging skills to the host service provider. Each consumer could buy as many gallons of gas as they wished at an established price. A goal of the present invention thus allows the consumer to act independently to purchase as much quantity of fuel as they wish at a convenient and reliable posted price without actually storing it.

One way to practice the current invention would be to identify an easily accessible and reliable central fuel price, preferably on the Internet, where customers could access daily average fuel prices. From there, the customer could watch daily average prices and lock in the price when it reached a desired level. One such option could be through the American Automobile Association's Daily Fuel Gauge Report accessed on the World Wide Web by manually typing in the site's location as a Uniform Resource Locator (“URL”) at http://www.fuelgaugereport.com. This site lists daily average fuel prices for metropolitan areas all over the country and includes three grades of gasoline and diesel. Other readily available fuel price sources could also be used.

Next, the present invention must allow a customer to purchase any quantity of fuel at the published or otherwise agreed fuel price. To minimize startup costs, issuing credit to a customer is just not realistically possible economically because of cash flow demands and the complexity of setting up such a program. Thus, a prepaid system is an attractive option to practice the present invention. A prepaid system is simple and finalizes the contract, setting the price and the dollar amount at one time, at the current average price of fuel.

There are several ways for the provider to make a profit using the system of the present invention. These may be accomplished while also maintaining the objects of the invention. For example, the provider can make a profit on an overall gas position. The provider may contract fuel with its customers every day, effectively selling fuel. To offset the price risk associated with these transactions, the provider can buy futures contracts to offset those sales. By balancing the sales of fuel with the purchase of futures contracts, the provider can position itself to take advantage of trends in the fuel markets that will generate profits. That is, it is “hedged” in such a way that the provider can make money on being long or short in its overall position. The provider, having expertise in futures trading and economic (supply and demand) analysis, will use those skills by using market research in assessing its position in the futures market relative to the quantities currently sold to its customers. The seasonality of gas price movements allows for a reasonable and effective offset of risk. The provider will also use the prepaid money to finance the margin requirements of the futures positions, effectively eliminating the need to borrow money for margin requirements. Cost efficiencies are strong, thus increasing the ability of the company to profit. The prepaid cash can also be invested and earn income from the time the customer initializes the contract and the time the gas is consumed and the company has to pay invoices from the fuel companies with which it is dealing. Thus, by balancing the sales of fuel with the purchase of futures contracts, the provider can position itself to take advantage of trends in the fuel markets that will generate profit. It will also invest the prepaid dollars from the prepaid purchases and use those investments to bring profits to the provider.

The present invention should allow the user/consumer the most flexibility and yet allow the provider to track usage. The necessity of tracking usage as it occurs is critical. There are several types of readable media, as described below, that could be used. For one embodiment of the present invention, a debit card volume quantity (e.g., gallon) balance would have some leeway in the gallons credited to each card. For illustrative purposes, a penalty could be used, such as ten cents per gallon, for use beyond what has been prepaid. The cost of gas per gallon could also be a predetermined amount, a previous prepaid rate, current daily rate, and the like. The discretion to implement this cost and amount of overage could be set by the provider. This feature of the present invention can allow a consumer to not have to pump exactly the contracted amount. The provider can communicate with the customer when they are over their prepaid gallons and request payment or purchase of additional gallons for the card. The provider can also suspend customer purchases if they exceed their prepaid limit. If this debit situation is abused, the provider would have the right to cancel the debit card.

On a very basic level, the present invention could involve a cash exchange, with a consumer sending their gas receipts to the service provider/company and the provider paying back the difference between the contracted price and the pump price. A basic credit card could also be used, such as one used under the registered service name VISA, or even a fuel provider fleet card. Many fuel companies issue fleet cards for businesses to use for their employees or drivers to use while on the road. They already have programs to keep detailed information of all transactions by individual card members.

With the information provided by the fleet card systems, the provider need only subtract each customer's use from their contracted gallon balance. The provider could then issue monthly statements or would check balances in between upon request.

The present invention allows adaptation to a software system with Internet access that can provide user/customers their balance on a provider web site, as well as additional markets. Generally, a user/customer interested in locking in the price of gasoline could first access the website, such as www.gaspricecap.com. There, a general explanation of the program is found, along with market updates, a newsletter distribution system, a quick explanation on how to sign up, and the terms of the agreement for the program. The program stresses the importance of becoming independent of gas price fluctuations and the ability to budget fuel expenses by locking in a price.

If a user is interested in joining the program, the terms of agreement would then be filled out, signed, and sent to a provider (such as Economic Analysis and Research (EAR)) by mail. The terms of the agreement may be acknowledged or verified using many methods known in the art. In one form, a customer's signature on the terms of agreement in order to begin their participation in the program may be used. Digital or electronic “signature” methods known in the art are also possible The terms outline the program and stress that it is a prepaid purchase, by contract with a provider, of fuel for their use only. There are no sell-backs by the customer if prices do go up. The customer must use the gallons purchased on the card. The customer can buy as many gallons as they want and can use the card any time they want.

Upon user acceptance of the terms of agreement, provider may send the user a debit card, which is not yet activated. They are then ready to lock in the price when the price achieves a desired level.

The user/customer is assigned a home metropolitan area in which they buy the majority of their gasoline. A home metropolitan area is used for setting the price of the gasoline because the price of gas varies so much around the country. Fuel can be purchased outside the customer's home area, but price differences will be taken into consideration.

By watching the average price of fuel in their home area, customers can determine at what price they want to lock in. When the price gets to a level that customers want to buy, they can contact the provider with the dollar amount, gallons, and/or price they would like to lock in. The provider can then verify the purchase, such as through an email back to the user, stating the name and address of the customer, the price, dollars and gallons that will be credited to their account, the home area and the grade of gasoline. The customer can then respond back that they accept the terms of the contract and then payment occurs. In one form of the invention, an invoice for the gas will be sent to the customer, and they can pay by check or electronic transfer (currently PayPal). When the payment is received, their card will be activated, and the customer is then ready to use the card at any gas station that takes the card.

The fleet card service monitors all transactions from each card. The billed and unbilled use of the cards is available for viewing and downloading from the fuel companies, so the provider can monitor card use at any time. Gallon balances can be given at the request of the customer, and monthly statement of the account can be emailed to the customers. Each customer is responsible for the use of their card. If it is lost or stolen, they must contact the provider so that the card can be deactivated.

If fuel is purchased outside the home metropolitan area, and the average price that day, such as on www.fuelgaugereport.com, is higher than the home area on the day it is purchased, then that dollar difference equivalent (gallons times the price difference) will be deducted from the customer's account by dividing the dollar amount by the average price of the gallons currently contracted and deducting that gallon amount from the account. If the price of gas outside the home metropolitan area is lower than the home area, that dollar difference is credited to the customer to be used the next time they purchase gas.

The same formula applies to the grade of gas that is purchased. The customer can purchase regular, mid-grade, high octane, or diesel fuel when they lock in their price. If a different grade is purchased, the gallons or dollars in the account will be adjusted to reflect the difference just as it was when adjusting for the price if the gas was purchased in a different metropolitan area. Pricing can be determined using an appropriate average pricing mechanism, such as found in the American Automobile Association's Daily Fuel Gauge Report accessed on the World Wide Web at http://www.fuelgaugereport.com.

The customer can add to their gallon balance at any time by purchasing more fuel. After the initial purchase, the customer can add to their balance by contracting more gallons and paying for those gallons. When payment is received, those gallons will be added to their account.

There are other pricing alternatives besides the spot market purchases and the daily average price. The customer can use this system as a “fuel bank,” putting money into their account for the purpose of contracting gasoline at a future time. For example, the customer can deposit $50 per month into their account and then use that money to lock the price in at a later time.

There are also different pricing programs the provider can offer. Initially, forward pricing for use in specific future time periods, average pricing, where the customer can lock in the price of gas on a certain day of the week, month or year in certain predetermined times and dollar amounts (average pricing), lock in the gas futures price but not the difference between the futures and the metropolitan gas price (hedged to purchase), lock in the difference between the futures price and their metropolitan gas price but not the futures price (basis contract), or pay for the provider to lock in their prices for them in a gas pricing agreement. All of these programs would require prepayment of the fuel or a deposit (advance) in order to participate.

The customer can contract for future purchases of gasoline by contracting for purchases at a date in the future. The customer could purchase gasoline for purchases beginning a year in the future, for example, by locking in that price. This could be a negotiated price between the provider and the customer based on historical differences and other market influences and conditions between gas prices at the pump and the futures price that relates to that delivery period. The customer would still need to pay for the gasoline at the time of the contract, but may be able to lock in lower prices in the future than they are at present.

Average pricing would be an easy way for the consumer to avoid having to make decisions on when to buy gas. The provider could lock in a predetermined dollar amount of gas, for example $20, each Tuesday. The customer could use this balance at any time, and they would have an average price based off the unused gas gallon balances they have in their account.

The hedged to purchase and basis contracts are based on understanding the differences between the futures price for fuel and the local pump price for fuel in any metropolitan area. These differences change, and a customer that uses larger amounts of fuel may want to take advantage of those differences. These programs are based off those differences.

In a hedged to purchase contract, the customer locks in the futures price for the fuel, but does not set the difference. The difference used would be the difference for the time period the customer wanted to lock in the price of fuel. They could use the current value or a future use period that would be negotiated between the customer and the provider. To participate in this program, a partial payment of the fuel is required, depending on the amount of time before the fuel use period is set.

In the basis contract, the customer would lock in the difference in the fuel price and futures price for that time period, for the current or a future time of use, but not the futures price. The customer would have to lock in the futures price for the contract before the predetermined use period would begin. No prepayment is required for this program until the futures price is set.

The provider will also offer to price the fuel for a customer for a fee, under a written agreement that describes the timing and dollar amount of the purchases for the customer.

Other customer purchasing plans may be developed as the business grows and customer demands for service are considered.

Other features of the present invention may include methods to allow a customer to view their own account information, including purchases, dollars, and gallons pumped at which locations, etc.

The present invention is designed to be as simple as possible for the consumer to use and yet provide the necessary protection and profit opportunity for the provider. The provider also provides market information and other services to help the consumer in their decisions to purchase fuel at the lowest possible prices.

This program could be expanded into other markets that would allow the consumer to purchase other commodities that are traded in the futures markets or could otherwise be hedged, such as natural gas, propane, electricity, lumber, and other consumer goods that can be traded in quantity and hedged in a liquid futures market. The provider reserves the right to use the same basic system to accomplish the same service for the consumer in those other markets in the future.

Turning now to the figure, a basic flow is illustrated of how the systems and methods of the present invention may be practiced and is shown generally at 10. At the initial step, a user accesses the method at 12. This can be by various means but, at present, most likely this access point would be the Internet. At Access point, the user selects various options, as shown at Step 14. If a user wants to participate in the program, they must establish an account at Step 16. Establishing an account can be by various methods known in the art, such as acceptance of terms and conditions of use, credit check, identification information and verification, and the like. If the acceptance procedure fails, for whatever reason, the system returns to Start. If a user is allowed access to the system at Step 18, the user is provided with means to make the fuel transaction at Step 20, which is activated by the user at Step 22 by, for example, contracting and prepaying the amount due.

Another user option is found at Step 24. Here, a user may identify a purchase price for the commodity that is sought for purchase, such as fuel. As described above, one such method of identifying a price for the fuel is by looking up the American Automobile Association's Daily Fuel Gauge Report at http://www.fuelgaugereport.com. Such reports can be divided by geographic area, fuel type grade, etc.

Another user option is found at Step 26, where a user may purchase a volume quantity of the commodity, such as fuel. As described above and as illustrated, a user may elect to purchase a quantity of fuel at Step 28. The system proceeds to Step 30, where a user is prompted to select a quantity of gas that has an established price based on, for example, what is found at Step 24 and the geographic home base of the user. The system provider will credit the account and acknowledge this through the delivery of a Personal Identification Number (PIN) number or other means known in the art. Once an activated account has been credited, the user is free to use the card to purchase the fuel within the agreed time frame allowed for purchase, as shown in Step 34. From time to time, lost contact, no communication for a period of time, or lack of use of the card may result in revocation of use. Other factors, as described above, include adjustments for purchasing outside the home base of the user, purchase of a different grade of fuel, etc.

Also at Step 26 is the option to participate in an average pricing program at Step 36, which was described above, but can include weekly predetermined purchase value amounts or purchasing when a daily price reaches a certain value, as shown in Step 36.

Other general options available to a user of system 10 are shown at Step 40 and may include general provider information, terms of agreement, newsletters, account access, and the like.

In general, the present invention can be realized as methods or systems in hardware, software, or a combination of hardware and software of a computer system, including a computer network system, which may include the Internet. The present invention can be realized in a centralized fashion, in one computer system, or in a distributed fashion, where different elements are spread across several computer systems. Any kind of computer system or other apparatus adapted for carrying out the methods described herein is suited. A typical combination of hardware and software may include a general purpose computer system with a computer program that, when being loaded and executed, controls the computer system such that it carries out the systems and methods described herein. The present invention may also be voluntarily embedded in a computer program product (or any computer usable medium having computer readable program code embodied therein) which comprises all the features enabling the implementation of the methods and systems described herein and which, when loaded in a computer system, is able to carry out these systems and methods.

Computer program or computer program product, in the present context, means any expression, in any language, code, or notation, of a set of instructions intended to cause a system having an information processing capability to perform a particular function, either directly or after either or both of the following: (a) conversion to another language, code, or notation; and (b) reproduction in a different material or electronic form.

In addition, the present invention may use a portable object carried by a user having readable data as a means to effect a purchase. The medium used in conjunction with the readable data may be a card (i.e., credit card type), a magnetic strip preferably based on a card, a barcode strip, an electronic chip preferably associated with a card, a radio-wave readable medium such as an electronically enhanced key ring, fingerprints, retinas, personal digital assistant (PDA), and/or a mobile telephone.

The readable data on the medium can be an amount of fuel in gallons which remains on the card or which is originally purchased. The readable data may also or, in the alternative, be an ID code particular to the consumer or medium, an authentication, a validation, and/or some other data which is tied to the amount of gasoline in gallons for the card. The readable data may also simply be the raised numbers, or the like identified on the card.

The reader can be a conventional reader/scanner associated with current fuel pumps. The reader may also be a reader/scanner associated with one of the types of mediums listed above. The reader reads the readable data in order to transfer the readable data to a computer system. The reader may also operate to write on the medium, such as writing the remaining amount of gallons of gasoline for the medium, or account as reflected by the reduced amount of dispensed gasoline. Other purchase or identification data may also be written to the medium.

The computer system communicates with the reader in order to acquire the read data. The computer system may hold a central database which includes accounts associated with the readable data. The computer system can then identify the account being used by the readable data and, in turn, adjust the amount of dispensed fuel from the amount in gallons of prepaid gasoline associated with the readable data.

The description of the present invention herein is presented to enable any person skilled in the art to make and use the invention and is provided in the context of particular applications of the invention and their requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method to pre-purchase a quantity of a commodity that is traded in a futures market or could otherwise be hedged, the method comprising the steps of:
establishing a commodity purchase account for a provider to allow a user purchase of the commodity at a predetermined volume quantity, at a set price;
delivering to user a means to effect the purchase of a commodity;
transferring funds representing the purchase of a predetermined quantity of a predetermined commodity from a purchaser to a user;
crediting the purchaser's commodity purchase account with the funds;
utilizing the transferred funds to effect the purchase of the predetermined quantity of the predetermined commodity;
subsequently delivering at least a part of the commodity purchase in kind from a commodity vendor to the user; and
debiting the user's commodity purchase account in accordance with the quantity of the commodity delivered to the user.

2. The method of claim 1, wherein said account is established through the steps of printing a user form, signing said form, and delivering said signed form to said provider.

3. The method of claim 1, wherein said means to effect the purchase is a device having readable data.

4. The method of claim 3, wherein said device having readable data is a credit card.

5. The method of claim 1, wherein said means to effect the purchase has a radio-wave readable medium.

6. The method of claim 1, further comprising the step of delivering a price quote to a user on request.

7. The method of claim 1, wherein said step of transferring funds representing the purchase of a predetermined quantity of a predetermined commodity from a purchaser to a user comprises pricing said commodity uses forward pricing, wherein a user may purchase a specific volume of the commodity at a predetermined price.

8. The method of claim 1, wherein said step of transferring funds representing the purchase of a predetermined quantity of a predetermined commodity from a purchaser to a user comprises pricing said commodity using average pricing wherein the user can lock in the price of the commodity on a certain day of the week, month or year in certain predetermined times and dollar amounts.

9. The method of claim 1, wherein said step of transferring funds representing the purchase of a predetermined quantity of a predetermined commodity from a purchaser to a user comprises pricing said commodity can be locked in the futures price of the commodity, but not the difference between the futures and the geographic distribution of the commodity price (hedged to purchase).

10. The method of claim 1, wherein said step of transferring funds representing the purchase of a predetermined quantity of a predetermined commodity from a purchaser to a user comprises pricing said commodity to lock in the difference between the futures price and geographically distributed price, but not the futures price (basis contract).

11. The method of claim 1, wherein said step of transferring funds representing the purchase of a predetermined quantity of a predetermined commodity from a purchaser to a user comprises pricing said commodity to pay for the provider to lock in their prices for the user by a pricing agreement.

12. A prepaid volume-based purchasing system for a commodity traded in a futures market or could otherwise be hedged, comprising:
a medium including readable data to effect the purchase of a commodity,
a reader operable to read the readable data,
a computer system operable to analyze the readable data and identify a remaining volume of a commodity associated with the readable data,
wherein the computer system maintains a user commodity purchase account for a provider to allow a user to purchase the commodity at a predetermined volume quantity, at a set price, allows transferring funds representing the purchase of a predetermined quantity of a predetermined commodity from a purchaser to a user, credits the purchaser's commodity purchase account with the funds, utilizes transferred funds to effect the purchase of the predetermined quantity of the predetermined commodity, and debiting the user's commodity purchase account in accordance with the quantity of the commodity delivered to the user.
